(19) United States
(12) Patent Application Publication
(10) Pub. No.: US 2024/0227981 A1
(43) Pub. Date: Jul. 11, 2024

(54) WHEEL HUB

(71) Applicant: BIKTRIX ENTERPRISES INC., Saskatoon (CA)

(72) Inventors: Roshan Thomas, Saskatoon (CA); Joshua R.E. Grasby, Maple Ride (CA); Rylan Harry Grayston, Canora (CA)

(21) Appl. No.: 18/563,850

(22) PCT Filed: May 24, 2022
(86) PCT No.: PCT/IB2022/054858

§ 371 Date: Nov. 22, 2023

Related U.S. Application Data
(60) Provisional application No. 63/202,066, filed on May 26, 2021.

(51) Int. Cl. B62M 9/10; B60B 27/00; B60B 27/02; B60B 27/04; B62L 1/00; B62M 6/40; B62M 6/90

(52) U.S. Cl. CPC B62M 9/10; B60B 27/0052; B60B 27/023; B60B 27/047; B62L 1/00; B62M 6/40; B62M 6/90

(57) ABSTRACT

An example of an apparatus is provided. The apparatus includes a hub body to connect to a tire. The hub body is substantially cylindrical. The apparatus also includes a spindle to support the hub body. The spindle is coaxially disposed within the hub body. Furthermore, the spindle is to connect to a frame. In addition, the apparatus includes a bearing connected to the hub body and the spindle to provide rotation between the hub body and the spindle. Also, the apparatus includes a fixed driver connected to the hub body to rotate with the hub body relative to the spindle. The apparatus further includes a multi-speed sprocket mounted on the fixed driver. The multi-speed sprocket rotates with the fixed driver relative to the spindle.

### BACKGROUND

The bicycle powered by a cyclist uses a chain to transfer power from the foot pedals and cranks to the rear wheel. On most bicycles, the chain transfers power through a range of sprockets, which allows the cyclist to find the right pedaling cadence and speed. A freewheel mechanism is used to allow the pedals to transfer power to the wheel while at the same time allowing the bicycle to coast without the rear wheel causing the pedals to spin.

Electric assist bicycles are known, where an electric motor is used to assist the cyclist with pedaling. By assisting the pedaling of the bicycle, a cyclist will use less energy as well as be able to travel faster. In particular, the power levels transferred through such electric assist bicycles can be increased up to three times or more the pedaling power form a cyclist. Electric assist motors may be mounted in the middle of the bicycle and include a freewheel mechanism to allow the motor to under-spin compared to the drive chain. Furthermore, the freewheel mechanism in the electric assist motor allows the motor to spin without driving the cranks and pedals as this may be uncomfortable and unsafe for the cyclist. Furthermore, the freewheel mechanism in the electric assist motor is generally designed and rated for the electric assist power level.

### BRIEF DESCRIPTION OF THE DRAWINGS

Reference will now be made, by way of example only, to the accompanying drawings in which:

FIG. 1A is a perspective view of an example apparatus to be used as a hub of a wheel of a bicycle;

FIG. 1B is a cross-section view of the example apparatus of FIG. 1A through the line 1B-1B;

FIG. 2A is a perspective view of the example fixed driver of the example apparatus of FIG. 1A;

FIG. 2B is an end view of the hub body of the example apparatus of FIG. 1A;

FIG. 3A is a perspective view of another example apparatus to be used as a hub of a wheel of a bicycle;

FIG. 3B is a cross-section view of the example apparatus of FIG. 3A through the line 3B-3B;

FIG. 4 is an exploded view of some of the components of the example apparatus of FIG. 3A;

FIG. 5A is another view of some of the components of the example apparatus of FIG. 3A from the other end;

FIG. 5B is a perspective view of some of the components of the example apparatus of FIG. 5A with a brake rotor;

FIG. 6A is a view of some of the components of another example apparatus to be used as a hub of a wheel of a bicycle;

FIG. 6B is a perspective view of the example apparatus of FIG. 6A with a brake rotor;

FIG. 7A is a perspective view of another example apparatus to be used as a hub of a wheel of a bicycle;

FIG. 7B is a cross-section view of the example apparatus of FIG. 7A through the line 7B-7B;

FIG. 8 is a perspective view of an example apparatus to transport a cyclist;

FIG. 9 is a perspective view of another example apparatus to transport a cyclist; and

FIG. 10 is a flowchart of an example method of operating an electric assist bicycle.

### DETAILED DESCRIPTION

In describing the components of the device and alternative examples of some of these components, the same reference number may be used for elements that are the same as, or similar to, elements described in other examples. As used herein, any usage of terms that suggest an absolute orientation (e.g. “top”, “bottom”, “front”, “back”, etc.) are for illustrative convenience. Such terms are not to be construed in a limiting sense as it is contemplated that various components will, in practice, be utilized in orientations that are the same as, or different than those described or shown.

Electric assist bicycles are known. In general, electric assist bicycles are built on top of conventional bicycle designs where a motor may be mounted at a location substantially in the middle of the bicycle. Accordingly, an electric assist bicycle includes many components that are designed for a cyclist powered bicycle. For example, electric assist bicycles may include a freewheel mechanism in the rear wheel which can be redundant since the electric assist motor may include another freewheel mechanism. Furthermore, since the freewheel mechanism in the rear wheel is designed for torques that are typically applied by a human cyclist, the torques applied by an electric assist motor may exceed the design specifications for the freewheel mechanism in the rear wheel resulting in a failure mode where power can no longer be reliably transmitted to the rear wheel, and the bicycle becomes un-rideable or unsafe. To address this issue, the freewheel mechanism may simply be serviced and replaced more frequently or upgraded to withstand the typical forces of the electric assist motor.

In addition to being prone to failure when using an electric assist to drive a freewheel mechanism designed for pedaling by a cyclist, freewheel mechanisms may suffer from rotational backlash due to a finite number of internal engagement points. The existing drawbacks or limitations of freewheel mechanisms in the rear wheel hub are further apparent in a number of specialty bicycle types, for example in downhill racing bicycles configured with impact-absorbing front and rear suspension systems integrated into the frame parts, the rear wheel hub freewheel mechanism may introduce unwanted variables into dynamic chain tension and chain speed, as well as effective chain length due to the rear wheels suspended movement in relation to the pedals. A further example exists in trial bicycles, where the cyclist relies on maintaining balance while standing the bicycle only from the rear wheel, and a rear wheel hub freewheel mechanism may introduce unwanted variables into the relationship between rear wheel and pedals.

An apparatus is provided to drive an electric assist bicycle. In particular, a rear wheel hub without a freewheel mechanism, designed to work with an external freewheel mechanism is described. The external freewheel mechanism, such as one in the electric assist motor, may provide substantially similar functionality outside of the rear wheel hub. The fixed-drive assembly provides a mechanical interface between multi-speed sprocket sets and the rear wheel to provide a combination of multi-speed exposed sprockets with fixed-drive advantages. The external freewheel mechanism may be mounted to the bottom bracket, on the crank arm, on the motor shaft, or in another location. The fixed-drive assembly also provides substantially immediate power transmission and is capable of withstanding higher torques. Furthermore, the reduction of moving parts allows for tighter seals to keep out contamination, reduced weight, and increased long-term performance.

Unlike a conventional fixed-gear bicycle, which has a single-speed gear in a given configuration, the apparatus provides a multi-speed sprocket configuration with multiple gears, such as up to about fifteen speeds in a single sprocket group, or cassette. In some examples, the sprocket group may fit over the industry standard nine-spline unidirectional cassette interface, commonly referred to as a “freehub driver” on a freewheel hub. Therefore, the freehub driver element of the present invention fulfills the compatibility with existing commercially-available sprocket groups.

Accordingly, the apparatus provides a much stronger interface between the multi-speed sprocket set and the bicycle hub with its wheel. In addition, the apparatus provides immediate engagement at any point in the rotation of the wheel since the interface is permanently locked. This locked interface may include a sprocket interface rigidly affixed to the wheel hub body by either a mechanical interface, or formed as a unitary body. This fixed-drive configuration also synchronizes drive chain movement with rotation of the rear wheel, providing greater drive control at either the pedals or an electric assist motor.

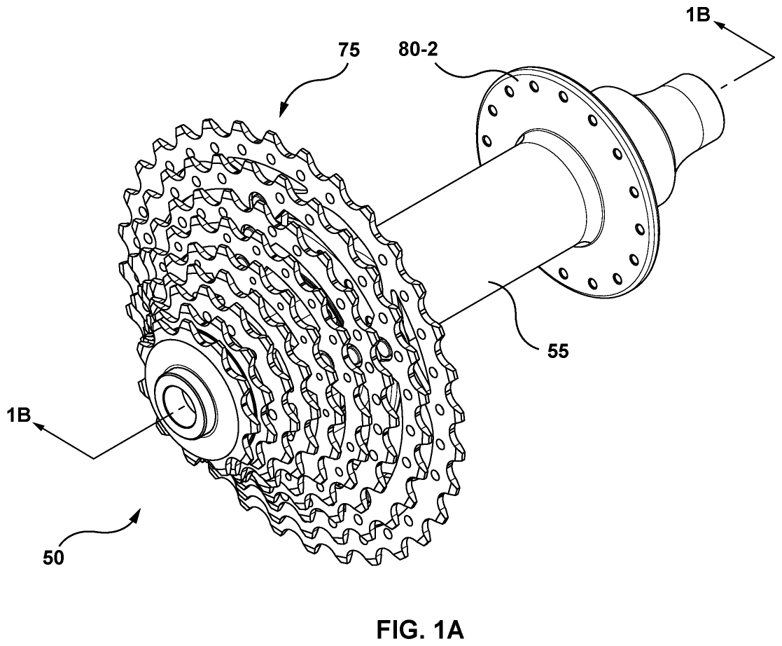

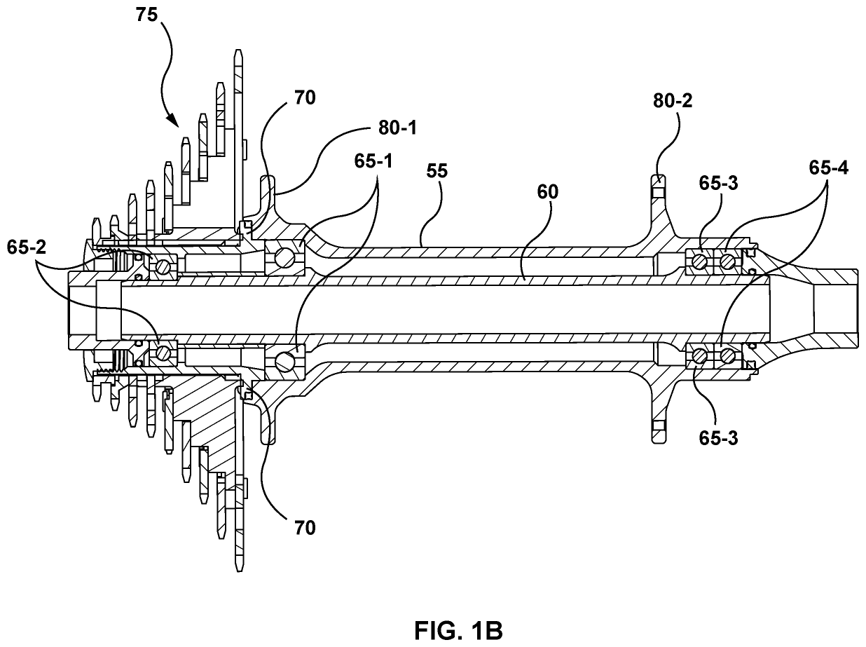

Referring to FIGS. 1A and 1B, an apparatus 50 to be used as a hub of a rear wheel of a bicycle is generally shown. In the present example, the apparatus 50 is configured to support a rear wheel of an electric assist bicycle. However, in other examples, it is to be understood by a person of skill with the benefit of this description that the apparatus 50 may be applied to other vehicles such as a fully electric bicycle or a human powered bicycle. The apparatus 50 includes a hub body 55, a spindle 60, a plurality of bearings 65-1, 65-2, 65-3, 65-4 (generically, these bearings are referred to herein as “bearing 65” and collectively they are referred to as “bearings 65”), a fixed driver 70, and a multi-speed sprocket 75.

The hub body 55 is to connect to a wheel of the bicycle, such as the rear wheel. In the present example, the hub body 55 is substantially cylindrical and rotates with the wheel of the bicycle. The material from which the hub body 55 is constructed is not particularly limited. For example, the hub body 55 may be machined from a singular bar of alloy, such as 6061 or 7075 aluminum, for example, with a computer numerically controlled (CNC) mill-turn center utilizing a sub-spindle transfer, and live-tooling features, to complete machining operations in a single cycle. It is to be understood by a person of skill with the benefit of this description that the hub body 55 is made from any rigid material capable of withstanding the typical forces exerted on hub body 55 by the wheel. In some examples, the hub body 55 may be made with another rigid metal or other material, such as a hard plastic, which may be made from injection molding techniques or three-dimensional printing. In other examples the hub body 55 may be made from other materials such as composite materials.

The manner by which the hub body 55 connects to the tire is not limited. In the present example, spoke flanges 80-1 and 80-2 (generically, these spoke flanges are referred to herein as “spoke flange 80” and collectively they are referred to as “spoke flanges 80”) are disposed on the hub body 55. The spoke flanges 80 are connected or formed with the hub body 55. The spoke flanges 80 are to receive a spoke and to provide an anchor point for an end of the spoke. At the other end of the spoke, a connection mechanism is provided to connect to the tire. The spokes are not particularly limited and may be made from a wide variety of materials, such as steel, aluminum, titanium, or other material with sufficient physical characteristics. In other examples, the apparatus 50 may substitute the spoke flanges 80 with another suitable component to connect the hub body 55 to the tire. For example, the hub body 55 may be connected to or formed with alloy spokes, such as on an alloy spoke wheel.

In the present example, the spindle 60 is to support the hub body 55. In particular, the spindle 60 is to connect to a frame of the bicycle and allow the hub body 55 to rotate relative to the spindle 60 around an axis. The spindle 60 is located within the hub body 55 and is coaxial with the hub body 55. It is to be appreciated by a person of skill with the benefit of this description that the spindle 60 is not limited and may include separate components such as a spacer attached to each end to interface with the frame of the bicycle at either end along with various rings and seals, which substantially seal the internal components of the hub body 55 from external elements. In other examples, the spindle 60 may be a unitary body. Furthermore, the material from which the spindle is constructed is not particularly limited. In the present example, the spindle 60 is manufactured with a conventional CNC lathe from round-bar 6061 aluminum. In other examples, different metals and alloys may be used. Further examples may also include materials described above in connection with the hub body 55.

The spindle 60 and the hub body 55 are rotatably connected by the bearings 65 in the present example. The bearings 65 are not particularly limited and may include ball bearing systems or other types of bearing systems that provide relative rotational motion between the spindle 60 and the hub body 55. The configuration and placement of the bearings 65 are also not particularly limited. In the present example, the bearing 65-1 is located directly inboard of the fixed driver 70, situated in close proximity to the drive-side spoke flange 80-1. The bearing 65-2 is positioned to support the outboard side of the fixed driver 70, situated approximately midway between the spoke flange 80-1 of hub body 55 and the outboard end of an axle spacer. A bearing spacer may be used to support the position and spacing between the bearing 65-1 and the bearing 65-2. A cassette lock ring may also be disposed at the end of the spindle 60 to secure the components. The bearing 65-3 and the bearing 65-4 are disposed in a paired configuration, supporting the spindle 60 at the non-drive end of hub body 55. Although the present example illustrates four bearings 65 used to connect the hub body 55 to the spindle 60, it is to be appreciated by a person of skill with the benefit of this description that more or fewer bearings may be used. For example, the spindle 60 may be connected to the hub body 55 with a single bearing if the components are rigid enough to support the forces and torques. As another example, additional bearings 65 may also be added to distribute the forces.

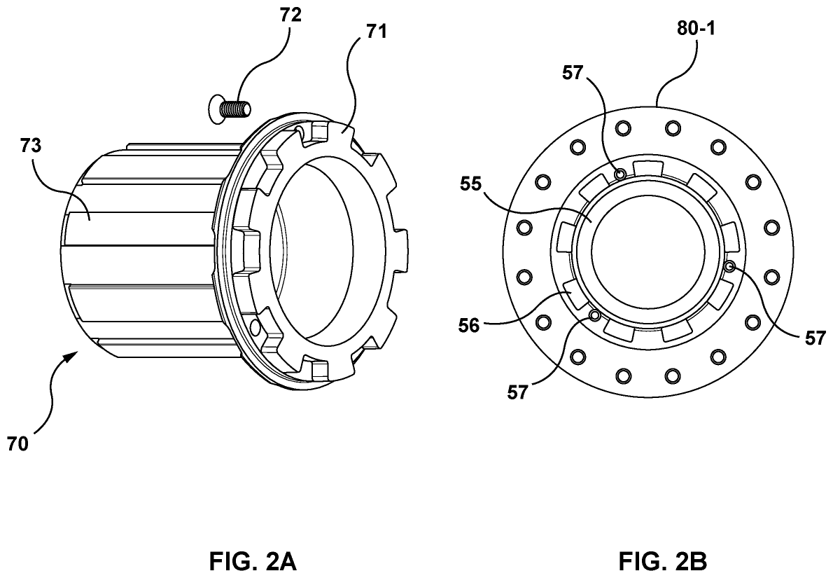

The fixed driver 70 is connected to the hub body 55 and generally configured to rotate with the hub body 55 relative to the spindle 60. The manner by which the fixed driver 70 is connected to the hub body 55 is not particularly limited. In the present example, the fixed driver 70 is removable and may be connected via a mechanical interface. Referring to FIGS. 2A and 2B, the mechanical interface between the fixed driver 70 and the hub body 55 is shown in greater detail. The mechanical interface includes a plurality of teeth 71 disposed on the fixed driver 70 to mate and engage with complementary teeth 56 disposed at an end of the hub body 55. The fixed driver 70 is connected to the hub body 55 with one or more fasteners 72, such as screws, bolts, or rivets, configured to be received by holes 57. In other examples, the mechanical interface may be modified to include more or fewer teeth. The mechanical interface may also have a different shape, such as a regular or irregular polygon. The mechanical interface may also be a pressed fitment interface that may or may not include fasteners. It is to be appreciated by a person of skill with the benefit of this description that such an interface may be semi-permanent to allow for the removal of the fixed driver 70 from the hub body 55, such as for replacement due to normal wear and tear, or to replace the fixed driver 70 with another one that is more suited to an application. In further examples, a rubber seal, such as an O-ring, may be placed between the fixed driver 70 and the hub body 55 to protect internal components such as the spindle 60 from external elements. In further examples, the fixed driver 70 may be permanently connected to the hub body 55, such as by welding the parts together.

The manufacturing of the fixed driver 70 is not particularly limited and may involve machining an aluminum alloy, such as 6061 or 7075 aluminum, or from a ferrous alloy, such as a 300 series stainless steel alloy. Since the fixed driver 70 may be typically exposed to greater wear and tear than the rest of the hub body 55, the fixed driver 70 may be manufactured from a different material, such as a harder material or a more serviceable material than the hub body 55. In other examples, the fixed driver 70 may be formed from the same material as the hub body 55 in a unitary body with the hub body 55. It is to be appreciated that in such an example, the mechanical interface connecting the fixed driver 70 to the hub body 55 is absent and the combination of the fixed driver 70 and hub body 55 are machined from a single piece of material.

In the present example, the fixed driver 70 is to receive the multi-speed sprocket 75 which is mounted thereon. In the present example, it is to be understood that the multi-speed sprocket 75 is to rotate the fixed driver 70 which is rigidly connected to the hub body 55. Accordingly, the multi-speed sprocket 75 is to receive torque from the chain to rotate the hub body 55 relative to the spindle 60 and to drive the motion of the rear tire and the bicycle.

The manner by which the multi-speed sprocket 75 is connected to the fixed driver 70 is not particularly limited. In the present example, the multi-speed sprocket 75 includes teeth (not shown) to mate with the external teeth 73 of the fixed driver 70. The external teeth 73 of the fixed driver 70 is not particularly limited and may be formed through a machining process. In some examples, the external teeth 73 may be reinforced, such as with a different alloy or a coating to protect the external teeth 73 from the forces applied thereto. For example, the external teeth 73 may be anodized. In other examples, the external teeth 73 may also be coated with a harder material, such as a cobalt alloy or titanium nitride. In other examples, the mating interface may be modified to include more or fewer teeth. Furthermore, the mating interface may also have a different shape, such as a regular or irregular polygon.

The apparatus 50 may further include additional components to provide additional functionality, such as to connect the apparatus to the bicycle frame or to improve the operation of the components described above. For example, the apparatus 50 may include a lock ring cap threaded into the fixed driver 70 to retain the multi-speed sprocket 75. A spacer may also be included at either end of the spindle 60 that may be plugged into the bearings 65 to connect to the bicycle frame.

It is to be appreciated by a person of skill in the art that the manufacture and materials of the components of the apparatus 50 are not particularly limited. While some examples are provided above in connection with some components, other components may be manufactured differently. Some metal components, such as some of the components described above and other minor parts, such as spacers or fasteners, may be composed of an aluminum alloy to be suitably protected from excessive wear and corrosion by batch anodizing of the parts, which produces a durable surface finish. In other examples, different materials such as titanium, stainless steel or plastic that are inherently not susceptible to corrosion may be used. Components may also be impregnated with a permanent dye to cosmetically color the appearance. Prior to anodizing, the components may also be chemically electropolished, or mechanically abraded or polished, to produce a specific surface finish.

Furthermore, the size, shape, and orientation of the components may be modified. For example, the hub body 55 and the spindle 60 may be modified to a bicycle frame with any width, or axle configuration. As another example of a modification, the spindle 60 may be solid or hollow and include threaded or integrated spacers.

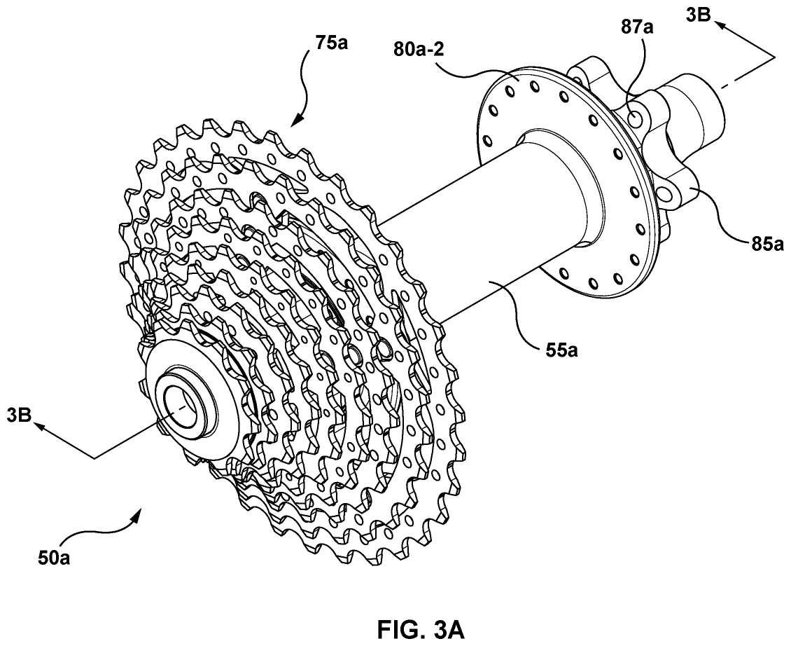

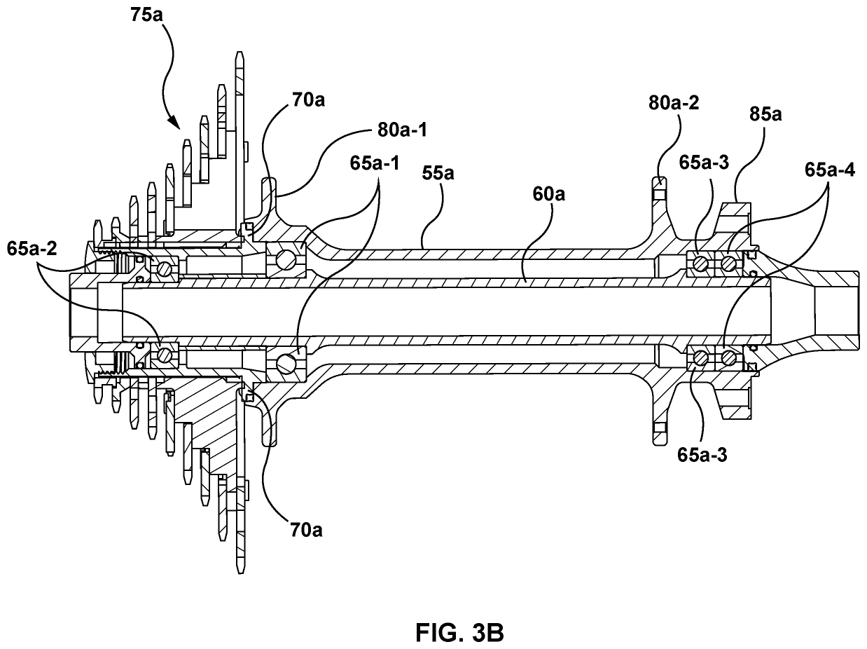

Referring to FIGS. 3A and 3B, another example of an apparatus 50a to be used as a hub of a rear wheel of a bicycle is generally shown. Like components of the apparatus 50a bear like reference to their counterparts in the apparatus 50, except followed by the suffix “a”. The apparatus 50a includes a hub body 55a, a spindle 60a, a plurality of bearings 65a-1, 65a-2, 65a-3, 65a-4 (generically, these bearings are referred to herein as “bearing 65a” and collectively they are referred to as “bearings 65a”), a fixed driver 70a, a multi-speed sprocket 75a, and a brake rotor mount 85a.

In the present example, the apparatus 50a includes a brake rotor mount 85a to receive a brake rotor and to provide a feature to which the brake rotor can be secured to the hub body 55a. The brake rotor mount 85a is not particularly limited and may include a plurality of holes through which a fastener 86a may be used to connect the brake rotor 90a to the brake rotor mount 85a. In the present example, the brake rotor mount includes six holes 87a. However, it is to be appreciated by a person of skill with the benefit of this description that the brake rotor mount 85a may be modified to include different connection mechanisms, such as ones with more holes or fewer holes. Furthermore, the holes may be threaded to accommodate a fastener 86a, such as a screw. In other examples, the holes may receive a bolt fastened with a nut or a rivet.

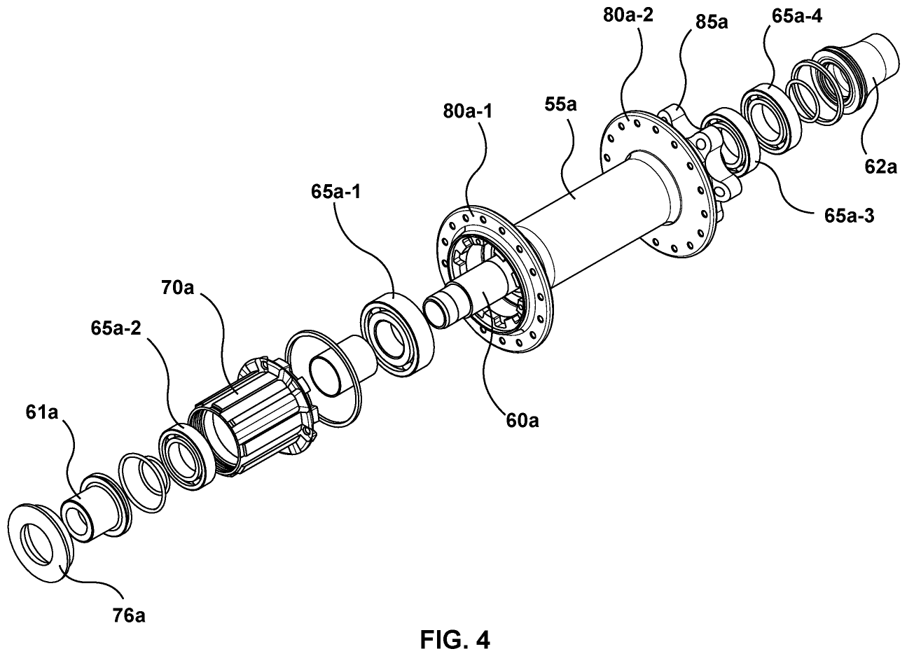

Referring to FIG. 4, an exploded view of some of the components of the apparatus 50a is shown in greater detail. As shown, the hub body 55a is connected to the fixed driver 70a at one end. The bicycle wheel is built to rotate around the apparatus 50a with steel spokes attaching from the rim of the wheel to the spoke flanges 80a-1 and 80a-2 through the spoke holes or apertures. A lock ring cap 76a is disposed at an end of the fixed driver 70a and threaded into the fixed driver 70a to retainer or affix the multi-speed sprocket 75a.

An axle spacer 61a and an axle spacer 62a are disposed at opposite ends of the spindle 60a and secured onto the ends of the spindle 60a to engage with the bicycle frame. The axle spacer 61a and the axle spacer 62a are not particularly limited and may be dimensioned to augment the spindle 60a such that the apparatus 50a can be used with frames of different widths. The manner by which the axle spacer 61a and/or the axle spacer 62a are secured to the spindle is not particularly limited. For example, the axle spacer 61a and/or the axle spacer 62a may include threading at an end to mate with threading at an end of the spindle 60a. In another example, the axle spacer 61a and/or the axle spacer 62a may be secured with a locking ring (not shown). The locking ring is not limited and may be any metallic or non-metallic ring with sufficient mechanical properties to secure the axle spacer 61a and/or the axle spacer 62a.

It is to be appreciated by a person of skill with the benefit of this description that the lock ring cap 76a allows for the multi-speed sprocket 75a to be removed of changed. For example, depending on the intended use of the bicycle or cyclist preference, the multi-speed sprocket 75a may be substituted to obtain more gears or to provide different gear ratios.

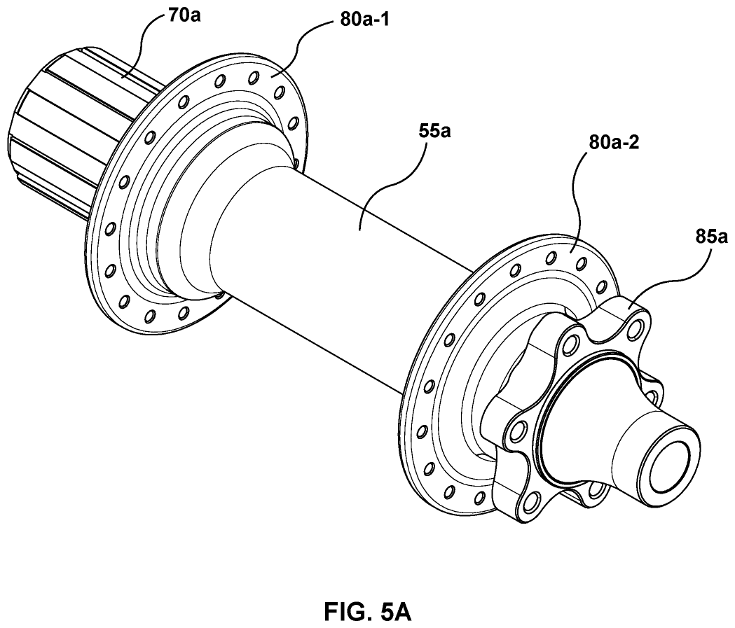

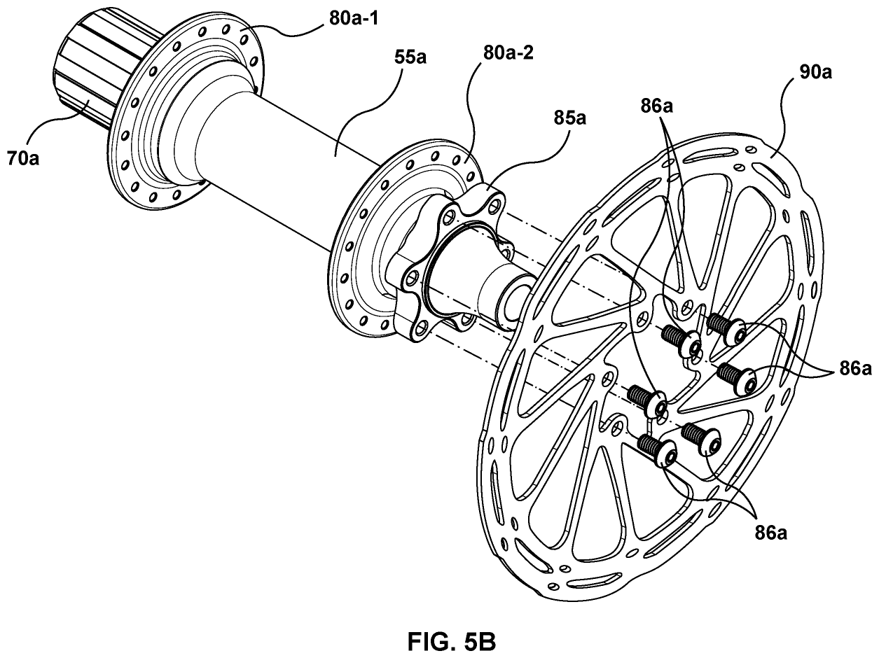

Referring to FIGS. 5A and 5B, the brake rotor mount 85a is shown in greater detail. In the present example, the brake rotor mount 85a receives a brake rotor 90a. The brake rotor 90a is secured to the brake rotor mount 85a with fasteners 86a, such as screws.

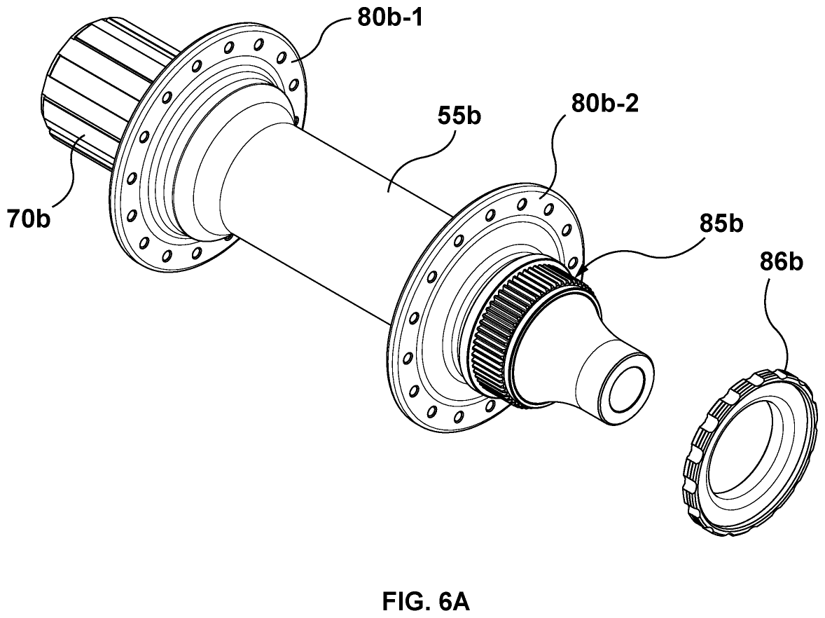

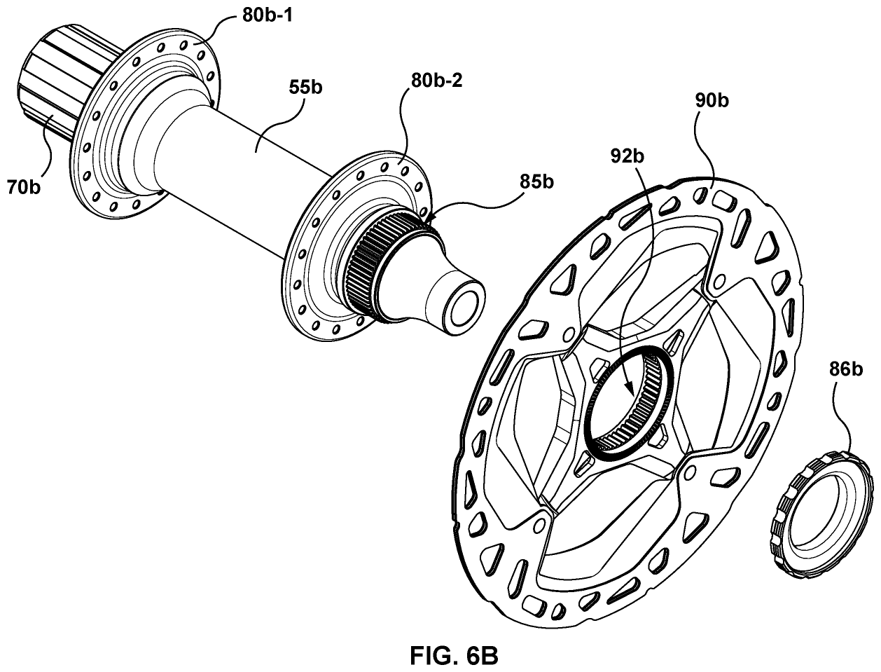

Referring to FIGS. 6A and 6B, another example of a brake rotor mount 85b is generally shown. It is to be appreciated by a person of skill with the benefit of this description that the brake rotor mount 85b may be added to any apparatus such as the apparatus 50 or the apparatus 50a. In the present example, the brake rotor mount 85b includes a spline connector to receive a complimentary spline connector 92b on the brake rotor 90b. The brake rotor 90b may then be secured to the brake rotor mount 85b with the retaining ring 86b that may be connected onto the brake rotor mount 85b such as via a threaded mechanism.

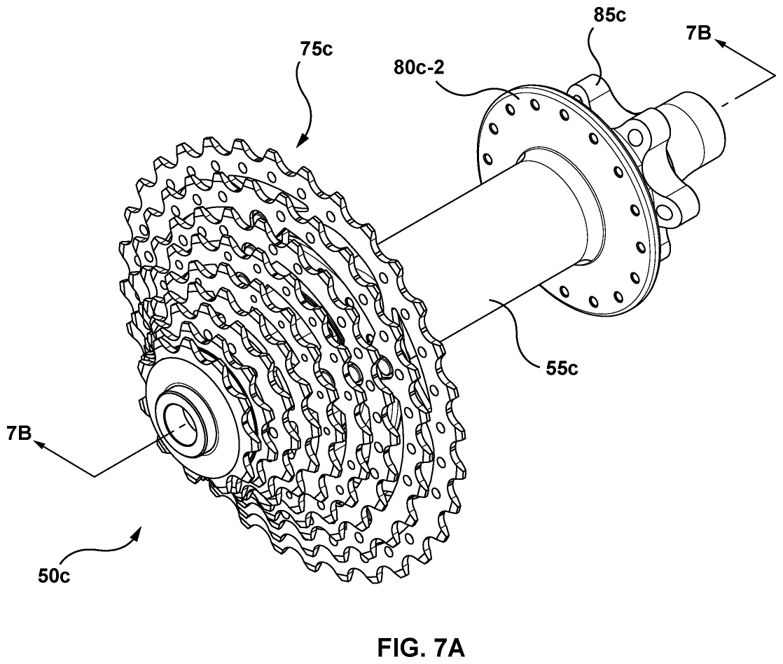

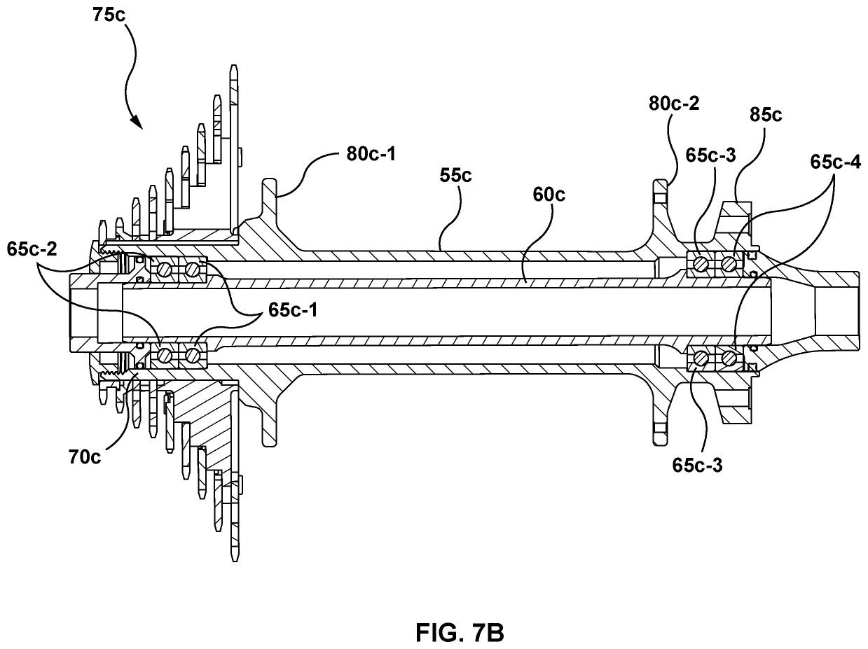

Referring to FIGS. 7A and 7B, another example of an apparatus 50c to be used as a hub of a rear wheel of a bicycle is generally shown. Like components of the apparatus 50c bear like reference to their counterparts in the apparatus 50a or the apparatus 50, except followed by the suffix “c”. The apparatus 50c includes a hub body 55c, a spindle 60c, a plurality of bearings 65c-1, 65c-2, 65c-3, 65c-4 (generically, these bearings are referred to herein as “bearing 65c” and collectively they are referred to as “bearings 65c”), a fixed driver 70c, a multi-speed sprocket 75c, and a brake rotor mount 85c.

In the present example, the fixed driver 70c and the hub body 55c are an integrated, singular component. Accordingly, the hub body 55c with the fixed driver 70c may be formed as a unitary body. The manner by which the hub body 55c with the fixed driver 70c are formed is not particularly limited. For example, the hub body 55c with the fixed driver 70c may be machined from a single piece of metal. In other examples, the hub body 55c with the fixed driver 70c may be molded into shape.

The spindle 60c may be simplified in this example. In particular, the spindle 60c may be assembled through the bearings 65c in paired configurations. It is to be appreciated by a person of skill in the art with the benefit of this description that this configuration may be applied to other examples, such as to a modified version of the apparatus 50.

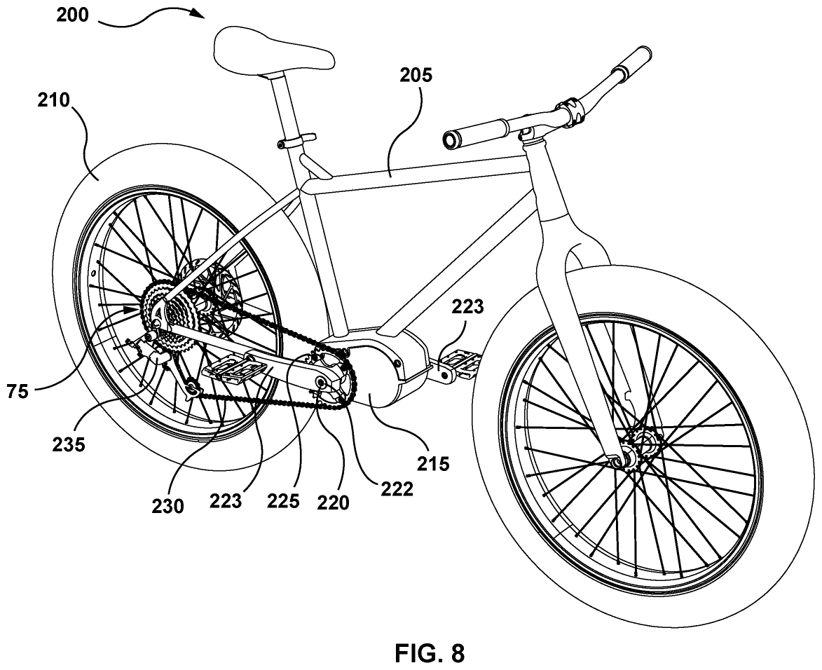

Referring to FIG. 8, an apparatus 200 to transport a cyclist is generally shown. In the present example, the apparatus 200 may also be referred to as a bicycle, and in particular, an electric assist bicycle. The apparatus 200 includes a frame 205, a rear wheel 210, a multi-speed sprocket 75, a motor 215, a motor spindle 220, a freewheel mechanism 222, a pedal arm 223, a motor sprocket 225, and a chain 230.

The apparatus 200 is an electric-assisted, mid-motor drive line bicycle. The frame 205 is to support the apparatus 200 with a cyclist mounted thereon and may be a frame used for various conventional bicycles. The rear wheel 210 is mounted to the frame 205. The rear wheel 210 is to propel the frame 205 to provide motion. In the present example, the motor 215 may be an electric-assist motor mounted in the mid-lower region of the frame 205. The motor 215 is to rotate the motor spindle 220 during operation. A freewheel mechanism 222 couples the motor sprocket 225 to the motor spindle 220. The motor sprocket 225 is connected to the multi-speed sprocket 75 by a chain 230 to transfer power from the motor sprocket 225 to the multi-speed sprocket 75 to drive the rear wheel 210. The freewheel mechanism 222 allows the motor 215 to power the rear wheel 210 while providing free rotation for the motor sprocket 225. Accordingly, the freewheel mechanism 222 allows the motor sprocket 225 to rotate without causing the motor spindle 220 to rotate when the apparatus 200 is coasting.

In the present example, the motor spindle 220 may be connected to pedal arms 223 to allow a cyclist to manually pedal to propel the apparatus by driving the rear wheel 210. It is to be appreciated by a person of skill with the benefit of this description that freewheel mechanism 222 further allows the pedal arms 223 to be held stationary by a cyclist while the rear wheel 210 and chain 230 are in motion. In other examples, such as a fully electric bicycle that does not provide for pedaling, the pedal arms 223 may be omitted. It is to be appreciated by a person of skill with the benefit of this description that an additional freewheel mechanism (not shown) may be used to engage the motor spindle 220 with the motor sprocket 225 such that the motor sprocket 225 does not drive the motor spindle 220 while the apparatus 200 is coasting. This additional freewheel mechanism may be omitted such that the motor spindle 220 with the motor sprocket 225 are directly connected in examples where driving of the motor spindle 220 may be allowed to spin when the apparatus 200 is coasting.

The apparatus 200 includes a multi-speed shifting system 235 to cooperate with the multi-speed sprocket 75. In the present example, the multi-speed sprocket 75 includes nine sprockets. However, it is to be understood by a person of skill with the benefit of this description that more or less sprockets may be included depending on the intended application of the apparatus 200. In some examples, the multi-speed sprocket 75 may be substituted with a fixed gear or single-speed sprocket such that the shifting system 235 may be omitted.

In the present example, while coasting with the pedal arms 223 held stationary, the rear wheel 210 will continue to spin the multi-speed sprocket 75, the chain 230, and motor sprocket 225. Any electric assist power applied by throttle from the motor 215 will be immediately transferred to the already-moving driveline, delivering instant acceleration without any mechanical lag. In addition, a cyclist may apply additional motive power at any time through driving the pedal arms 223 and is free to operate the apparatus 200 without motor assistance, for example, after a battery for the motor 215 has been depleted.

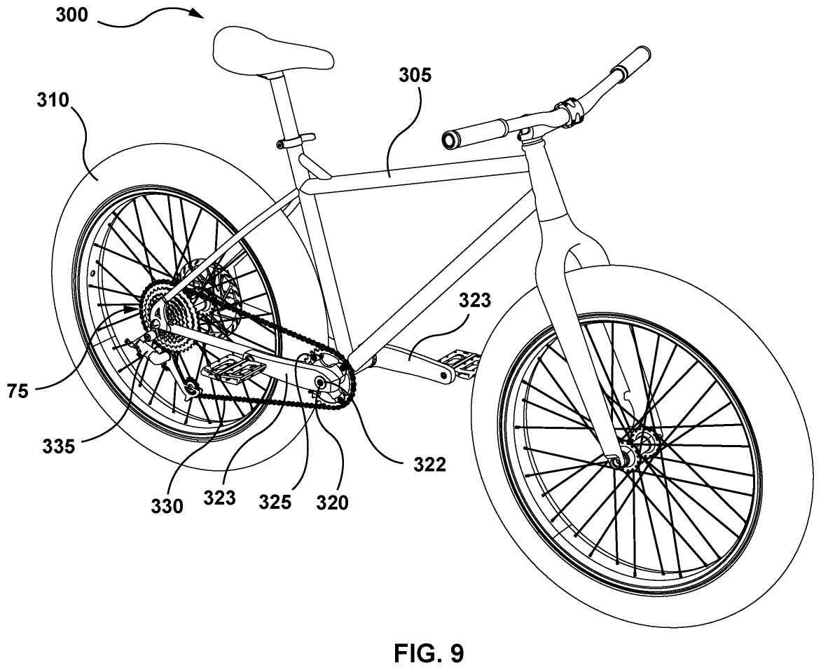

Referring to FIG. 9, an apparatus 300 to transport a cyclist is generally shown. In the present example, the apparatus 300 may also be referred to as a bicycle. The apparatus 300 includes a frame 305, a rear wheel 310, a multi-speed sprocket 75, a spindle 320, a freewheel mechanism 322, a pedal arm 323, a pedal sprocket 325, and a chain 330.

The apparatus 300 is a bicycle and the frame 305 is to support the weight of the apparatus 300 and a cyclist. The rear wheel 310 is mounted to the frame 305. The rear wheel 310 is to propel the frame 305 to provide motion. The pedal arms 323 are to receive power from a cyclist to rotate the spindle 320 during operation. A freewheel mechanism 322 couples the pedal sprocket 325 to the spindle 320. The pedal sprocket 325 is connected to the multi-speed sprocket 75 by a chain 330 to transfer power from the pedal sprocket 325 to the multi-speed sprocket 75 to drive the rear wheel 310. The freewheel mechanism 322 provides free rotation for the pedal sprocket 325. Accordingly, the freewheel mechanism 322 allows the pedal sprocket 325 to rotate without causing the pedal arms 323 to rotate when the apparatus 300 is coasting.

In particular, the freewheel mechanism 322 allows the pedal arms 323 to be held stationary by a cyclist while the rear wheel 310 and chain 330 are in motion.

The apparatus includes a multi-speed shifting system 335 to cooperate with the multi-speed sprocket 75. In the present example, the multi-speed sprocket 75 includes nine sprockets installed. However, it is to be understood by a person of skill with the benefit of this description that more or less sprockets may be included depending on the intended application of the apparatus 300. In some examples, the multi-speed sprocket 75 may be substituted with a fixed gear or single-speed sprocket such that the shifting system 335 may be omitted.

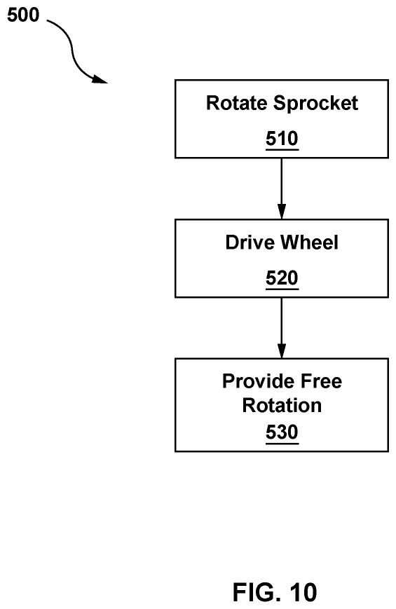

Referring to FIG. 10, a flowchart of a method of operating an electric assist bicycle is generally shown at 500. In order to assist in the explanation of method 500, it will be assumed that method 500 may be performed by the apparatus 200 with the apparatus 50 installed at the rear wheel 210. Indeed, the method 500 may be one way in which the apparatus 200 may be configured. Furthermore, the following discussion of method 500 may lead to a further understanding of the apparatus 200 and its components. In addition, it is to be emphasized, that method 500 may not be performed in the exact sequence as shown, and various blocks may be performed in parallel rather than in sequence, or in a different sequence altogether.

Beginning at block 510, the motor sprocket 225 is rotated by the motor 215 or a pedal arm 223. In the present example, the motor 215 rotates the motor spindle 220. The motor spindle 220 is mechanically connected motor sprocket 225, such as via the freewheel mechanism 222. Accordingly, the rotation of the motor spindle 220 is to cause the rotation of the motor sprocket 225. It is to be appreciated by a person of skill with the benefit of this description that when the apparatus 200 includes the freewheel mechanism 222, the motor sprocket 225 will be driven by the motor spindle 220 when the speed of the motor spindle 220 exceeds the speed of the motor sprocket 225 in some examples. Accordingly, when the apparatus 200 is coasting, the rotation of the motor sprocket 225 driven by the rear wheel 210 does not drive the motor spindle 220. In other examples, the freewheel mechanism 222 may be modified to allow for the rear wheel 210 to drive the motor spindle to charge a battery while the apparatus 200 is coasting.

The rotation of the motor sprocket 225 is to drive the rear wheel 210 at block 520. The motor sprocket 225 is connected to the multi-speed sprocket 75 via the chain 230. In the present example, the multi-speed sprocket 75 is fixedly connected to the rear wheel 210 without any freewheel mechanism. Accordingly, the mechanical connections between the motor sprocket 225 and the rear wheel 210 cause the motor sprocket 225 to drive the rear wheel 210.

Block 530 comprises providing free rotation of the pedal arm 223 from the rotation of the rear wheel 210 when the apparatus 200 is coasting. It is to be appreciated that by providing free rotation, the pedal arms 223 may be held stationary by a cyclist while the rear wheel 210 and chain 230 are in motion. This provides a more comfortable riding experience similar to a conventional bicycle with a freewheel mechanism in the rear hub. In addition, the fixed multi-speed sprocket 75 causes rotation of the chain 230 during coast may allow for the multi-speed shifting system 235 to operate without a cyclist pedaling if the apparatus is in motion. In particular, it allows for the moving of the chain 230 from a gear of the multi-speed sprocket 75 to another gear of the multi-speed sprocket 75 with the rotation of the rear wheel during coasting.

It is to be recognized that features and aspects of the various examples provided above may be combined into further examples that also fall within the scope of the present disclosure.

1. An apparatus comprising:
a hub body to connect to a tire, wherein the hub body is substantially cylindrical;
a spindle to support the hub body, wherein the spindle is coaxially disposed within the hub body, and wherein the spindle is to connect to a frame;
a bearing connected to the hub body and the spindle, wherein the bearing is to provide rotation between the hub body and the spindle;
a fixed driver connected to the hub body to rotate with the hub body relative to the spindle; and
a multi-speed sprocket mounted on the fixed driver, wherein the multi-speed sprocket rotates with the fixed driver relative to the spindle.

2. The apparatus of claim 1, further comprising a spoke flange connected to the hub body, wherein the spoke flange is to receive a spoke.

3. The apparatus of claim 1, further comprising a brake rotor mount to secure a brake rotor thereon.

4-5. (canceled)

6. The apparatus of claim 1, further comprising an axle spacer disposed at an end of the spindle to engage the frame.

7. The apparatus of claim 6, further comprising a non-metallic ring to secure the axle spacer, wherein the axle spacer is to be secured manually.

8. The apparatus of claim 6, wherein the spindle includes threading at the end to secure the axle spacer with complementary threading.

9. The apparatus of claim 1, further comprising a fastener to connect the fixed driver to the hub body.

10. The apparatus of claim 1, wherein the fixed driver and the hub body include complimentary teeth to engage each other.

11. The apparatus of claim 10, wherein the teeth of the fixed driver are reinforced.

12. The apparatus of claim 1, wherein the fixed driver and the hub body are connected via a press-fitment process to semi-permanently bond the fixed driver and the hub body.

13. (canceled)

14. An apparatus comprising:
a frame;
a rear wheel mounted on the frame;
a multi-speed sprocket mounted on the rear wheel, wherein the multi-speed sprocket is fixed to the rear wheel and rotates with the rear wheel;
a motor mounted on the frame at a mid-lower region;
a motor spindle to be rotated by the motor;
a motor sprocket coupled to the motor spindle;
a freewheel mechanism to couple the motor sprocket to the motor spindle, wherein the freewheel mechanism is to provide free rotation of the motor sprocket; and
a chain connecting the motor sprocket to the multi-speed sprocket, wherein the chain is to drive the rear wheel.

15. The apparatus of claim 14, wherein the rear wheel includes a spoke flange connected to a hub body, wherein the spoke flange is to receive a spoke.

16. The apparatus of claim 14, wherein the rear wheel includes a brake rotor mount to secure a brake rotor thereon.

17-18. (canceled)

19. The apparatus of claim 14, wherein the rear wheel includes an end cap to engage the frame.

20. The apparatus of claim 19, wherein the rear wheel includes a non-metallic ring to secure the end cap, wherein the end cap is to be secured manually.

21. The apparatus of claim 19, wherein the rear wheel includes threading to secure the end cap.

22. The apparatus of claim 14, further comprising a charging system coupled to the motor spindle, wherein rotation of the rear wheel provides energy to the charging system to charge a battery.

23. A method comprising:
rotating a motor spindle with a motor, wherein rotation of the motor spindle rotates a motor sprocket;
driving a multi-speed sprocket with a chain connected to the motor sprocket, wherein the multi-speed sprocket is fixedly connected to a rear wheel and wherein driving the multi-speed sprocket is to accelerate a bicycle; and
providing free rotation of a pedal arm from rotation of the rear wheel when the bicycle is coasting.

24. The method of claim 23, further comprising charging a battery when the bicycle is coasting.

25. The method of claim 23, further comprising moving the chain from a first gear of the multi-speed sprocket to a second gear of the multi-speed sprocket with the rotation of the rear wheel.
